(19) United States
(12) Patent Application Publication
(10) Pub. No.: US 2007/0241549 A1
(43) Pub. Date: Oct. 18, 2007

(54) Height Adjuster with Motion Clutch

(75) Inventors: Richard A. Boelstler, Lake Orion, MI (US); Robert J. Desmarais, Lake Orion, MI (US); David R. Arnold, Macomb, MI (US); Rudi Grzic, Sterling Heights, MI (US); Lawrence M. Refior, Romeo, MI (US); Steven R. Bell, Rochester Hills, MI (US)

Correspondence Address: KEY SAFETY SYSTEMS, INC.;PATENT DEPARTMENT, 7000 NINETEEN MILE ROAD, STERLING HEIGHTS, MI, 48314, US

(73) Assignee: KEY SAFETY SYSTEMS, INC., Sterling Heights, MI (US)

(21) Appl. No.: 11/690,550

(22) Filed: Mar. 23, 2007

Related U.S. Application Data
(60) Provisional application No. 60/744,670, filed on Apr. 12, 2006.

(51) Int. Cl. B60R 22/20

(52) U.S. Cl. 280/801.2

(57) ABSTRACT

A height adjuster (100) adapted for use with a seat belt system, the height adjuster including: a lock bar (110) having a lock side (116) with optional teeth (116a) and an opposing side (118); a lock lever (120) having an opening (122) therethrough, the lock bar receivable through the opening, a portion of the lock lever proximate the opening (122) configured as a lock edge (128) engagable with the lock side of the lock bar (110), the lock lever (120) movable between a disengaged position in which the lock edge is disengaged from the lock side and an engaged position in which the lock edge is engaged with the lock side of the lock bar; a clutch and actuator assembly (200) movably mounted to the lock bar and configured to move the lock lever between the disengaged position and the engaged position upon relative movement between the assembly (200) and the lock lever (120), the assembly (200) including a clutch portion (210) and an actuator portion (202).

This application claims the benefit of U.S. Provisional Application 60/744,670, filed on Apr. 12, 2006. The disclosure of the above application is incorporated herein by reference.

### BACKGROUND AND SUMMARY OF THE INVENTION

The present invention generally relates to a height-adjusting mechanism (height adjuster) for a D-ring (also called a web guide) of a seat belt system.

The shoulder belt 560 of a three-point seat belt system 562 is typically supported at or about shoulder level of the occupant by a web guide or D-ring 550 as generally illustrated in FIG. 16. The seat belt system also includes a seat belt retractor 561 operatively connected to the shoulder belt 560 and a lap belt 564 with a tongue 566, which is lockable within a buckle 568. The lap belt and buckle are appropriately anchored to the floor or seat frame. In some vehicles, the web guide is an integral part of the vehicle seat, while in others it is attached to one of the pillars (such as the B, C, or D-pillar) of the vehicle generally identified by numeral 570. The web guide or D-ring is typically constructed to provide a support surface, formed as a slot, over which the shoulder belt slides and the web guide includes means for mounting the D-ring to the seat or pillar. D-rings may also include a decorative cover 572. U.S. Pat. No. 5,601,311 is illustrative of a simple web guide. The D-ring is secured to a threaded bushing of the height adjuster typically by a shoulder bolt, which enables the D-ring to rotate (about the shoulder bolt).

It is now commonplace to mount the web guide on a vertically adjustable mechanism, which is typically called a height adjuster or an adjustable turning loop (ATL). Our commonly assigned U.S. Pat. No. 6,733,041 and U.S. patent application Ser. No. 10/843,121, filed May 11, 2004, are illustrative of this type of adjustable height adjusting mechanism for a seat belt system and these references are incorporated herein by reference.

The above referenced documents illustrate two related height adjusting mechanisms. Both mechanisms utilize a thin lock rail configured to be mounted to a vehicle. The lock rail is received within an opening in a lock lever. The lock lever is rotatable between a disengaged and an engaged position. When in an engaged position, the lock lever is in locking engagement with a side of the lock bar. In one embodiment this side of the lock bar may include a plurality of teeth along the length of the side. If the lock lever and associated mechanisms are manually slid upwardly on the lock bar, the lock lever ratchets upon the teeth of the lock bar. This ratcheting causes an audible ratcheting noise. The height adjuster of U.S. patent application Ser. No. 10/843,121 provided the means for eliminating the noise produced as the lock lever was slid upwardly over the lock bar teeth. More particularly, the patent application included a soft ring that was received about a portion of the lock bar and positioned directly above the lock lever. In view of the increased friction created between the soft ring and the lock bar, the soft ring resisted upward (or downward) motion and was less prone to moving than the lock lever. When the lock lever was moved upwardly, its upward motion was resisted by the soft ring, which generated an opposing reaction force on the lock lever, moving the lock lever to its disengaged position. With the lock lever disengaged from the lock bar, audible noise was eliminated as the lock lever no longer ratcheted over the teeth. The soft ring creates a resistive force, either when moved up or down the lock bar. Consequently, when the height adjuster is moved downwardly, this action requires additional forces to be applied to overcome the frictional forces created by the soft ring.

It is an object of the present invention to provide for an improved height adjusting mechanism for a seat belt system and one characterized by repeatable operation and one having a clutch that reduces frictional forces that need to be overcome.

Accordingly the invention comprises: a height adjuster 100 adapted for use with a seat belt system, the height adjuster comprising: a lock bar 110 having a lock side 116 with optional teeth 116a and an opposing side 118, the lock bar configured to enable mounting of the lock bar to a cooperating surface; a lock lever 120 having an opening 122 therethrough, the lock bar receivable through the opening, a portion of the lock lever proximate the opening 122 configured as a lock edge 128 engagable with the lock side of the lock bar 110, the lock lever 120 movable between a disengaged position in which the lock edge is disengaged from the lock side and an engaged position in which the lock edge is engaged with the lock side of the lock bar; a clutch and actuator assembly 200 movably mounted to the lock bar and configured to move the lock lever between the disengaged position and the engaged position upon relative movement between the assembly 200 and the lock lever 120, the assembly 200 including a clutch portion 210 and an actuator portion 202; the clutch portion including first means 212, 214, 232 for creating a drag or friction force on the actuator portion, upon upward movement of the lock lever and of the clutch and actuator assembly on the lock bar, for causing the lock lever to move to the disengaged position.

Many other objects and purposes of the invention will be clear from the following detailed description of the drawings.

### BRIEF DESCRIPTION OF THE DRAWINGS

FIG. 1 is a front isometric view of an assembled height adjusting mechanism according to the present invention.

FIG. 2 is a rear isometric view of the mechanism shown in FIG. 1 with a clutch and actuator assembly in its locked mode of operation.

FIG. 2a is another rear isometric view of the mechanism shown in FIG. 1 with the clutch and actuator assembly being moved downwardly on a lock bar.

FIG. 2b is a rear isometric view similar to the view of FIG. 2 but with the clutch and actuator assembly removed for the purpose of illustration.

FIG. 3 is an isolated view of a lock lever.

FIG. 4 illustrates the lock lever of FIG. 3 in a carrier.

FIG. 5 illustrates the lock lever and carrier of FIG. 4 positioned about the lock bar.

FIG. 6 is a side view illustrating in part the interrelationship between an activation button and a clutch and actuator assembly.

FIG. 7 illustrates the various parts of the clutch and actuator assembly.

FIG. 8 is a front view of the major portions of the clutch and actuator assembly.

FIG. 8a is a cross-sectional view through section line 8a-8a of FIG. 13.

FIG. 9 shows an assembled clutch and actuator assembly about a portion of the lock bar, which is also shown in FIGS. 2 and 5.

FIG. 10 is a top view of a rear clutch part of the clutch and actuator assembly of FIG. 9.

FIG. 10a is a top view of the clutch and actuator assembly of FIG. 9.

FIG. 11 is a rear isometric view of a front clutch part with an O-ring attached thereto.

FIG. 12 is a top view of the front clutch part.

FIG. 13 is a cross-sectional view showing the interrelationship between a front and rear clutch part.

FIG. 13a repeats the cross-sectional view of FIG. 13 and adds the lock bar.

FIG. 13b is a cross-sectional view along section lines 13b-13b of FIG. 13a.

FIG. 14 shows the relative movement of the front and rear clutch parts as well as the skewed movement of an O-ring.

FIG. 15 shows an alternate embodiment of the invention.

FIG. 16 shows a prior art three-point seat belt system.

### DETAILED DESCRIPTION OF THE DRAWINGS

The height adjuster (also referred to as a height adjusting mechanism) 100 utilizes many features of the height adjusters shown in U.S. Pat. No. 6,733,041 and U.S. patent application Ser. No. 10/843,121. More particularly, the height adjuster 100 includes a lock bar 110 configured to receive fasteners 112 and 114 that enable the adjuster 100 to be mounted to a structural member or portion of an automotive vehicle.

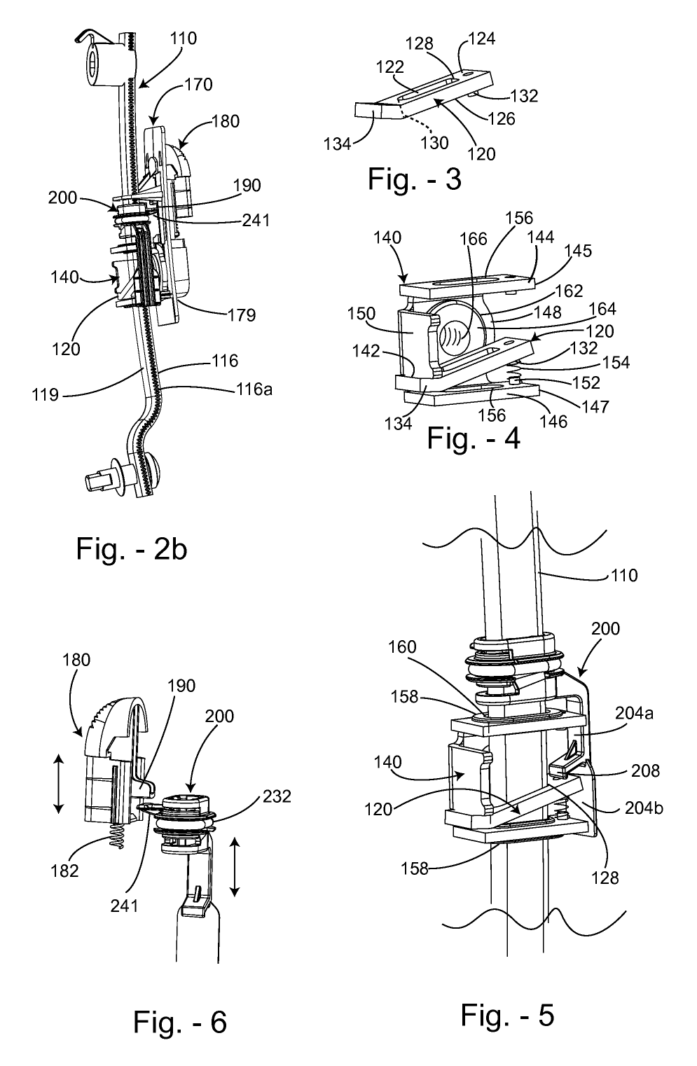

The lock bar 110, preferably made of a heat-treated steel, includes a first side 116 and an opposing second side 118. Side 116, in the illustrated embodiment, includes a plurality of teeth 116a. A lock lever 120 is received about the lock bar 110. The lock lever is shown in FIG. 2 as well as in isolation in FIG. 3. The lock lever 120 is preferably made of a heat-treated steel, having a hardness greater than that of the lock bar. The lock lever 120 includes a central opening 122, see FIG. 3, through which the lock bar 110 is slidingly received. The lock bar 120 includes an upper surface 124 and a lower surface 126. The intersection of the central opening 122 and the upper surface 124 forms a lock tooth or edge 128. Similarly, the intersection of the central opening 122 with the lower surface 126 forms an auxiliary lock tooth or edge 130. A small cylindrically shaped pin 132 extends from the lower surface 126. The lock lever 120 further includes an extending or pivot portion 134, which is received within a pivot space 142 of a carrier 140, shown in FIGS. 2, 2a and 4. The lock bar 110 further includes a front or front facing side 117 and rear or rear facing side 119, which typically faces toward or away from the passenger compartment of the vehicle.

Reference is made to FIGS. 2, 4 and 5. The carrier 140 is preferably made of stamped steel that is bent into the desired shape. The carrier includes a top 144, a bottom 146, and a front side 148 that links the top and bottom. The front side 148 includes a rearwardly bent extension that forms a rearwardly extending side 150. Side 150 is spaced from bottom 146 forming the pivot space 142. The bottom 146 includes a small pin 152 generally positioned opposite pin 132. A small helical spring 154 is received upon pins 132 and 152 and upwardly biases the lock lever toward its engaged position with a selected tooth/teeth 116a of the lock bar 110. FIGS. 2 and 5 show the lock lever 120 in its engaged position on the lock bar 110.

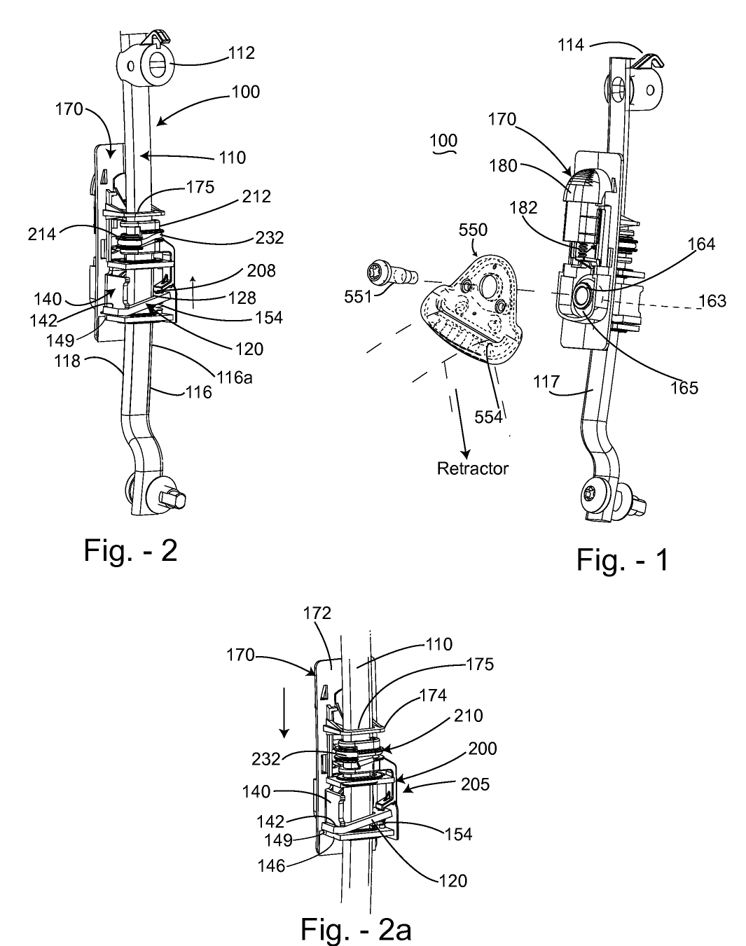

Each of the top 144 and bottom 146 includes an opening 156. A plastic or resilient bushing 158 having an opening 160 is received within each of the openings 156. The lock bar 110, as illustrated in FIGS. 2 and 5, is received within the opening 160 of the bushings 158. As can be appreciated, bushings 158 are optional; however, they do contribute to the reduction of acoustic noise between the carrier 140 and lock bar 110 by avoiding metal-to-metal contact. The front 148 of carrier 140 includes an opening 162. A bushing 164, having threads 166, is press-fit within opening 162. The bushing 164 shown in FIG. 1 also extends out of a button and trim assembly 170 and, as mentioned, receives shoulder bolt 551 to support the D-ring 550 that includes a slot 554 to receive the seat belt.

The button and trim assembly 170 is movable up and down on the lock bar 110 and moveable with the carrier 140 and lock lever 120. The button and trim assembly 170 includes a trim plate 172 having a first projection 174 (see FIG. 2a) extending from a rear surface of the trim plate with an opening 175. The lock bar is received in opening 175. The assembly 170 also includes two snaps 179 (only one of which is shown in FIG. 2a). The snaps lock into the bottom 146 of the carrier 140 thereby stabilizing the lower portions of plate 172 and maintaining alignment of the assembly 170 relative to the lock bar 110. The bushing 164 also extends through an opening 163 in the plate 172 and is secured thereto by a snap-ring or lock washer or other fastener 165. This construction maintains the alignment of assembly 170 relative to the lock bar, which permits the assembly 170 to slide along the lock bar with minimum friction therebetween.

The assembly 170 further includes an activation button 180 that is slideably received upon the front face of the trim plate. As illustrated in FIGS. 1, 2, 2a and 6, deactivation button 180 is in its deactivated position. In this position a bias spring 182 upwardly biases button 180. Button 180 includes an extension or projection 190 engageable with a projection 241 of assembly 200; this can be seen in FIG. 6. FIG. 6 includes the button, spring 182 and clutch and actuator assembly 200. When in the upper or deactivated position the button 180 and projection 190 are each disengaged from the clutch and actuator assembly 200. The arrows adjacent the button and assembly 200 illustrate the directions of movement of these parts.

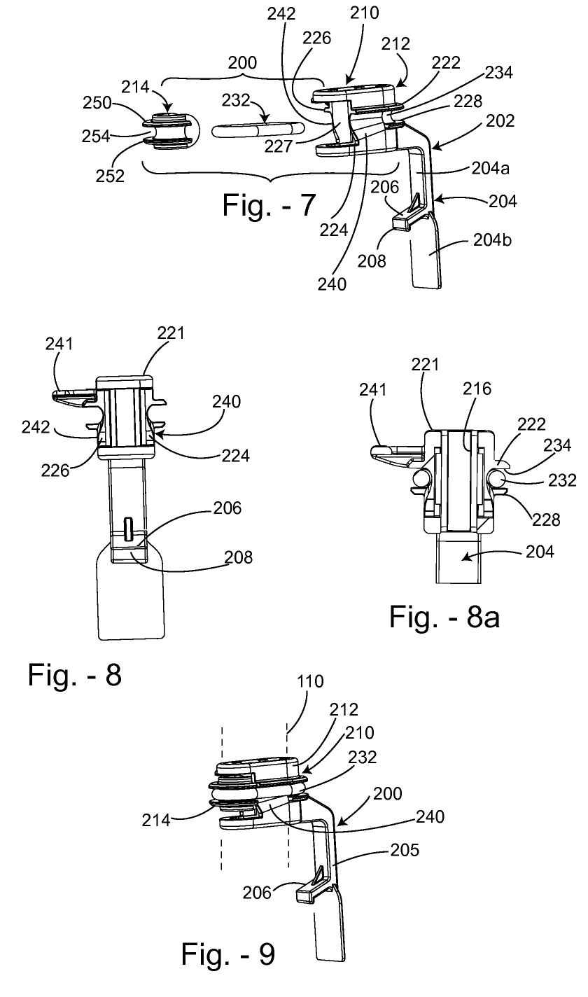

FIG. 7 illustrates the details of the clutch and actuator assembly 200. Assembly 200 comprises a first member 202 having a depending leg 204 separated into two portions 204a and 204b by a projecting member 206. Member 206 includes a downwardly extending arm 208 which, as illustrated in FIG. 5, operatively bears upon the lock lever 120. It is arm 208 that moves and rotates the lock lever 120 to its deactivated or unlocked position. The leg 204, projecting member 206 and arm 208 form the actuator portion 205 of the clutch and actuator assembly 200.

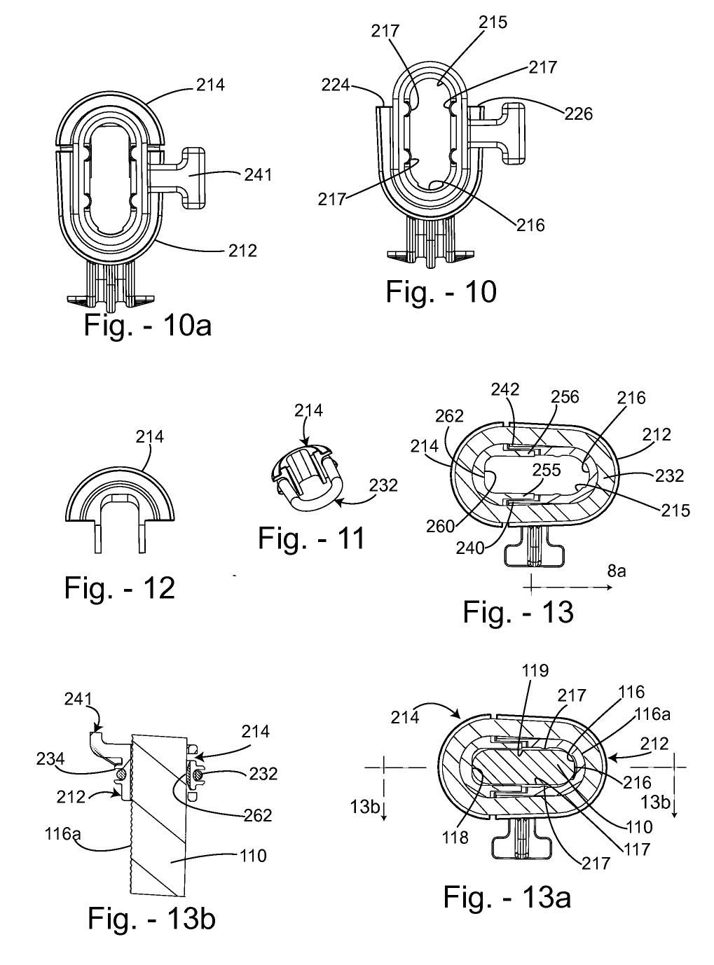

The upper portion of member 202 forms the clutch 210 portion of the clutch and actuator assembly 200. The clutch 210 includes a rear clutch part 212. Additionally, clutch 210 includes a front clutch part 214 that is relatively movable to the rear clutch part. As will be seen, the relative movement reorients an O-ring 232 relative to the rear and front clutch parts. As can be seen more clearly in FIG. 10, the rear clutch part is generally hollow and includes a central bore 215. Bore 215 includes a notch 216 at one end and opposing sets of projections 217. The opposing rolled edges formed along side 116 of a lock bar 110 are slideably received at the edges of notch 216 and the projections 217 slide upon faces 117 and 119 of the lock bar and stabilize the rear clutch part relative to the lock bar. The lock teeth 116a are spaced from the inside of notch 216 and do not contact the rear clutch part 212.

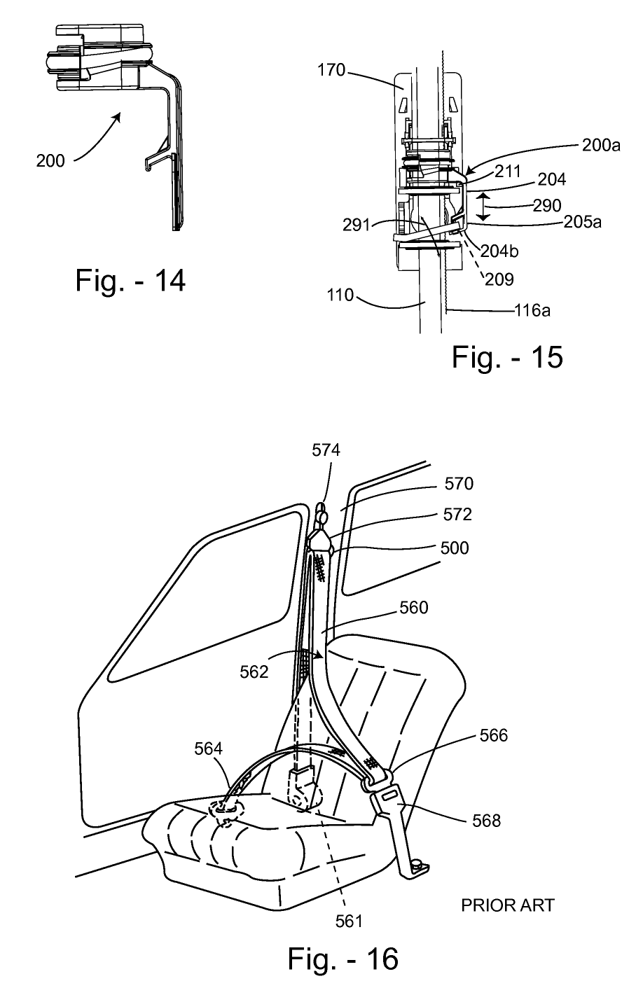

Reference is again made to FIGS. 5, 7 8 and 8a. The rear clutch part 212 includes a top 221 and a top partial peripheral wall 222 that extends from the first face 224 rearwardly to an opposite second face 226. As can be seen from FIG. 7, rear clutch part 212 is open between faces 224 and 226 forming an open mouth 227. A portion of side 118 of the lock bar 110 (also see FIG. 13a) extends outwardly from the rear clutch part 212 and is located between faces 226 and 224. The rear clutch part 212 includes a second peripheral wall 228 that is primarily located toward the rear of the rear clutch part 212 below wall 222. The rear portion of wall 222 and wall 228 form a groove 234 for receipt of an end portion of the O-ring 232. The rear clutch part 212 includes two opposing side walls 240 and 242, which terminate at faces 224 and 226 respectively. The side walls extend rearward of faces 224 and 226 and below wall 222.

As can be seen from FIGS. 7 and 8, each of the sidewalls 240 and 242 is arcuately shaped and bowed outwardly such that the largest separation between the side walls is at the bottom of the rear clutch part 220. As can be seen from FIG. 8, the narrowest separation between the side walls is generally immediately below peripheral 222. As can be appreciated, when the O-ring 232 is in this narrowest separation it is at its minimum energy level (minimally extended). The O-ring holds the front clutch part 214 to side 118 of the lock bar and applies a bias force proportional to the extension of the O-ring. As can be appreciated, the bias force imparted to the front clutch part 214 is at a minimum when the O-ring 232 is in its upper position.

As can be seen in numerous views, member 202 includes the projecting arm 241. Upon assembly, arm 241 is positioned opposite the button and trim assembly 170 and is acted on by projection 190, as previously mentioned.

The front clutch part 240, as illustrated in FIGS. 7, 11 and 12, includes peripheral walls 250 and 252, which create another groove 254 to receive an opposite end of O-ring 232. This relationship is also shown in FIGS. 9 and 13b. The front clutch part 214 further includes two projecting walls 255 and 256. As illustrated in FIGS. 13 and 13a, walls 254 and 256 are received between and are movable relative to walls 240 and 242 of the rear clutch part 212. The walls of the front clutch part 214 create a groove or recess 260 for receipt of side 118 of the lock bar 110. Walls 255 and 256 contribute in stabilizing the front clutch part 214 relative to the lock bar 110. A curved rib 262, shown in FIG. 13b, is located at the rear center of a groove 260 of the front clutch part 214. Rib 262 is arcuately shaped and bowed (convex) inwardly toward the center of groove 260 to minimize the material in contact with the lock bar 110 and to control and reduce friction therebetween.

FIGS. 1, 2, 5, and 9 show the lock bar and assembly 200 in a nominal, locked position with the lock lever tooth 128 engaging one of the teeth 116a of the lock bar. If D-ring 550 becomes downwardly loaded by the shoulder belt 560, such as during normal wear or in an accident, the downward forces imparted to D-ring 550 are transferred to the carrier 140 via bushing 164. This force urges the lock lever 120 downwardly causing its lock tooth 128 to further engage with and bite into the selected tooth 116a of the lock bar 110. In the locked position the O-ring 232 inwardly biases the front clutch part 214 into the lock bar, generating a normal force therebetween. This normal force will tend to keep the front clutch part 214 in place on the lock bar even if the rear clutch part is moved. Further, in this locked mode of operation, the bias spring 154 urges the lock lever upwardly, which in turn lifts the member 202 upwardly, which causes the rear clutch part (which is the top portion of member 202) to move up the lock bar a small distance relative to the placement of the front clutch part 214. In this orientation, the sides of O-ring 232 slide down the respective curved and conically tapered or contoured sides 240 and 242, as also shown in FIG. 2, toward the wider diameter portion of the rear clutch part stretching the O-ring 232, which applies a slightly higher force to the front of the front clutch part 214. The sides 240 and 242 upon which the O-ring 232 slides taper reward to the groove 234 (which acts as a fulcrum controlling the movement of the O-ring) and at the groove smoothly transition thereto, that is the dimension of the walls 240 and 242 in this area are about the same as that of the groove. Each wall 240 and 242 achieves its most inward inclination at its top, near the top peripheral wall 222, and flares and curves outward toward the lower extremes of each wall 240 and 242. As can be seen the lateral space between each wall 240 and 242 is at a minimum near the top peripheral wall 222 and is larger further away from the top peripheral wall 222. The flare and curvature of each wall 240 and 242 follows in a broad sense the shape of a conical wall segment.

If the user of the height adjuster 100 desires to relocate the D ring 550 to a lower position, the user will simultaneously grab the D-ring 550 and actuator button 180 and apply a downward force to the button with, for example, his index finger and also apply a downward force to the D-ring 550. Downward movement of button 180 is transferred to extending part 241 of member 202. The new positions of the front and rear clutch parts and O-ring are shown in FIG. 2b. This downward motion urges arm 208 against lock lever 120, causing the lock lever 120 to move against the bias force of spring 154. The downward movement of arm 208 pushes and translates the lock lever down the lock bar until the lock lever bottoms out on the bottom 146 of the carrier 140 or on the lower of the bushings 158 (if used).

Thereafter, further movement of arm 208 causes the lock lever to rotate within space 142 about the carrier 140 in a clockwise direction as viewed, for example, in FIGS. 2 and 5. This rotation of the lock lever disengages the lock lever tooth 128 from the selected tooth 116a of the lock bar, thereby permitting the lock lever 120, carrier 140, button and trim assembly 170, and clutch and actuator assembly 200 to be moved downwardly to a new position. Upon release of button 180, lock lever 120 enters its engaged mode with a newly selected tooth 116a. As can be appreciated, based upon the above, the lock lever 120, as it is moved downwardly (or upwardly with the button depressed) in the manner described, does not ratchet against the teeth 116a and generate an audible noise.

When the user desires to move the height adjuster 100 to a higher position along the lock bar 110, the user pushes assembly 170 upwardly. The upward movement of assembly 170, which is directly linked to carrier 140 through the fastener 164, causes carrier 140 to also move upwardly. The upward motion of the carrier 140 compresses spring 158, which urges the lock lever upwardly. The lock lever bears upon arm 208 causing member 202 of the clutch and actuator 200 to start to move upwardly. The upward motion of the member 202 is resisted by the friction or drag forces generated at the interface of the side 116 of the lock bar and the inner surface of the rear clutch part 212. This friction or drag force is transferred from the arm 208 to the lock lever 120, which causes the lock lever to disengage from the teeth of the lock bar 110, permitting the silent travel of the mechanism up the lock bar to a new position. When the user removes his hand from assembly 170, the lock lever will once again enter into its locked or engaged mode of operation. Also, as the assembly 170 is moved relatively upward in relation to the lock bar, the front clutch part 212 is dragged downward, the motion of which pulls O-ring 232 down each of the walls 240 and 242 which includes the relative forces on assembly 200.

Reference is briefly made to FIG. 15, which shows an alternate embodiment of the invention. The clutch and actuator assembly 200a of FIG. 15 includes many of the features shown and discussed above. For example, the clutch 210 is the same. The actuator 205, and more particularly portion 204b, is inwardly bent and includes an opening 209 therein. Pin 132 of the lock lever 120 is received within opening 209. The spacing between the inwardly bent portion 204b and arm 208 is sufficient so that the lock lever is loosely received in the space therebetween. This spacing permits the relative movement of the lock lever relative to the arm 208 and bent portion 204b and prevents the lock lever 120 from binding on these parts.

As can be seen, the bias spring 154 is not required in this alternate embodiment. The actuator portion 205 also includes a shoulder 211 at the top, inside region of leg 204. The operation of this embodiment is similar to the previously described embodiment. When it is desired to move the D-ring to a lower position (see arrow 290) on the lock bar, the button 180 is depressed and the D-ring held. The depression of the button 180 moves the clutch and actuator assembly 200a downwardly on the lock bar 110. Movement of the actuator portion 205a moves the lock lever to its deactivated position relative to the lock bar. If the button 180 is fully depressed, the shoulder 211 engages the top 144 of the carrier 140.

When it is desired to move the D-ring 550 to a higher location on the lock bar, the button and trim assembly is raised, which lifts the carrier 140 upwardly. The upward motion of the carrier 140 does not immediately cause the clutch and actuator assembly 200a to move upwardly. However, the upward motion of the carrier 140 lifts end 134 of the lock lever 120, which is located in the space 142 above bottom 146. This upward motion of end 134 effectively causes the lock lever to rotate (see arrow 291) about its opposite end, which is received between arm 208 and portion 204b. As before, rotation of the lock lever causes the lock lever to move to its disengaged position relative to the lock bar.

Many changes and modifications in the above-described embodiment of the invention can, of course, be carried out without departing from the scope thereof. Accordingly, that scope is intended to be limited only by the scope of the appended claims.

1. A height adjuster (100) adapted for use with a seat belt system, the height adjuster comprising:
a lock bar (110) having a lock side (116) with optional teeth (116a) and an opposing side (118), the lock bar configured to enable mounting of the lock bar to a cooperating surface;
a lock lever (120) having an opening (122) therethrough, the lock bar receivable through the opening, a portion of the lock lever proximate the opening (122) configured as a lock edge (128) engagable with the lock side of the lock bar (110), the lock lever (120) movable between a disengaged position in which the lock edge is disengaged from the lock side and an engaged position in which the lock edge is engaged with the lock side of the lock bar;
a clutch and actuator assembly (200) movably mounted to the lock bar and configured to move the lock lever between the disengaged position and the engaged position upon relative movement between the assembly (200) and the lock lever (120), the assembly (200) including a clutch portion (210) and an actuator portion (202);
the clutch portion including a rear clutch part (212), a front clutch part (214) and a resilient member (232) resiliently connecting the first and rear clutch parts, the resilient member ring configured to apply a compressive force on each of the front and rear clutch parts to urge these clutch parts against opposing sides (116, 118) of the lock bar, the rear clutch part movable relative to a first side (116) of the lock bar and the front clutch part movable relative to the opposing side (118) of the lock bar, the clutch configured to create a drag or friction force on the rear clutch part and hence on the actuator portion, upon upward movement of the clutch and actuator assembly on the lock bar, such drag force causing the lock lever to move to the disengaged position.

2. The adjuster according to claim 1 wherein the rear clutch part (212) is associated with a top portion of the actuator and wherein the front clutch part and the resilient member are movable relative to the rear clutch part on movement of the clutch and actuator assembly (200).

3. The adjuster according to claim 2 wherein the resilient member is an O-ring received within respective grooves (234, 154) of each of the rear and front clutch part.

4. The adjuster according to claim 2 wherein the rear clutch part includes opposing walls (240, 242) each of which is oppositely contoured.

5. The adjuster according to claim 4 wherein the opposing walls of the rear clutch part are contoured to effect an increase in the spacing between comparable regions of each wall in relation to the distance from a top toward a bottom of the walls.

6. The adjuster according to claim 5 wherein a rear portion of the front clutch part is received within an open region of the rear clutch part and is relatively movable thereto.

7. The adjuster according to claim 5 wherein the rear clutch part, the front part and the O-ring are configured to generate an increasing compressive force between the front and rear clutch parts with the O-ring in a lower position on the opposing walls (240, 242).

8. The adjuster according to claim 1 wherein a portion of the front clutch part facing the lock bar is concavely shaped.

9. The adjuster according to claim 1 wherein portions of the front and rear clutch parts facing opposing side walls of the lock bar include stand-offs (217).

10. The adjuster according to claim 1 wherein actuator (200) includes a projecting member (241) engageable to interact with a manually movable button (180) carried by and movable relative to the lock bar.

11. The adjuster according to claim 7 wherein the O-ring is received within grooves in each of the front and rear clutch part.

12. A height adjuster (100) adapted for use with a seat belt system, the height adjuster comprising:
a lock bar (110) having a lock side (116) with optional teeth (116a) and an opposing side (118), the lock bar configured to enable mounting of the lock bar to a cooperating surface;
a lock lever (120) having an opening (122) therethrough, the lock bar receivable through the opening, a portion of the lock lever proximate the opening (122) configured as a lock edge (128) engagable with the lock side of the lock bar (110), the lock lever (120) movable between a disengaged position in which the lock edge is disengaged from the lock side and an engaged position in which the lock edge is engaged with the lock side of the lock bar;
a clutch and actuator assembly (200) movably mounted to the lock bar and configured to move the lock lever between the disengaged position and the engaged position upon relative movement between the assembly (200) and the lock lever (120), the assembly (200) including a clutch portion (210) and an actuator portion (202);
the clutch portion including first means (212, 214, 232) for creating a drag or friction force on the actuator portion, upon upward movement of the lock lever and of the clutch and actuator assembly on the lock bar, for causing the lock lever to move to the disengaged position.
